(19) United States
(12) Patent Application Publication
(10) Pub. No.: US 2004/0203745 A1
(43) Pub. Date: Oct. 14, 2004

(54) Method and apparatus for efficient selection and acquisition of a wireless communications system

(76) Inventor: Rotem Cooper, San Diego, CA (US)

Correspondence Address: Qualcomm Incorporated, Patents Department, 5775 Morehouse Drive, San Diego, CA, 92121-1714, US

(21) Appl. No.: 10/092,700

(22) Filed: Mar. 6, 2002

(51) Int. Cl. H04Q 7/20

(52) U.S. Cl. 455/432.1; 455/434

(57) ABSTRACT

A mobile station includes processing circuitry and a memory. A group of wireless communications systems is selected in accordance with a predetermined system acquisition procedure. A received signal corresponding to each selected system is analyzed to determine a likelihood that the selected system would be acquired by the mobile station. The group of selected systems is reprioritized based on the results of the analysis to produce a more efficient system acquisition sequence. The mobile station then attempts to acquire a selected wireless communications system in accordance with the system acquisition sequence.

### RELATED APPLICATIONS

This application claims priority to U.S. Provisional Patent Application No. ______, filed on Feb. 5, 2002.

### BACKGROUND OF THE INVENTION

1. Field of the Invention

The present invention relates generally to wireless communications and, in particular, to a method and apparatus for efficiently selecting and acquiring a wireless communications system.

2. Description of the Related Art

A mobile device will often have access to more than one wireless communications system in its geographic region. The quality of the wireless services available to the mobile device may vary from system to system depending on the equipment used by each system, the features of the mobile device, the distance between the mobile device and local base stations, physical obstructions such as buildings and hills, and the volume of communications traffic on each system. The wireless communications systems may also support different multiple-access wireless communications protocols such as code division multiple access (CDMA), wideband CDMA (WCDMA), Advanced Mobile Phone Service (AMPS), Global System for Mobile communications (GSM), General Packet Radio Services (GPRS) or High Data Rate (HDR) technology (e.g., 1xEV technology). In addition, the fees charged to a user of the mobile device may vary depending on the time of day, the duration of the connection with the wireless communications system and whether the mobile device is listed as a subscriber of the wireless communications system.

To assist with the selection of a desirable wireless communications system, conventional mobile devices store data describing known systems in a preferred roaming list (PRL). The PRL typically includes a systems table which stores a system identifier (SID) and a network identifier (NID) for each known wireless communications system, and an acquisition table which stores acquisition parameters including band, frequency and mode, for the known wireless communications systems. Within the systems table, the wireless communications systems are often grouped by geographic region and sorted from the most desirable to the least desirable system in each region. The most desirable system in a particular geographic region is typically a subscriber system, but may also be a roaming system that offers the mobile device a favorable combination of low cost and high quality of service. Roaming systems offer wireless services to non-subscriber mobile devices, usually at a much higher fee than subscription services, and may be desirable when the mobile device enters a geographic region that is outside the coverage area of the mobile device's subscription service, when the subscription services are blocked or otherwise unavailable, or when the subscription services are only available at an unacceptably low level of quality.

During a mobile device's power-up sequence, attempts are made to acquire and register with the most desirable wireless communications system that is available to the mobile device in its current geographic region. In one approach, the mobile device identifies its current geographic region and then steps through the entries in the systems table, from the most desirable system in the identified geographic region to the least desirable system in the identified geographic region, until a system acquisition and registration attempt is successful. The mobile device may also attempt to acquire and register with a new wireless communications system during operation. For example, the connection between the mobile device and a current wireless communications system may be lost, requiring the acquisition of a new system by the mobile device. In addition, the wireless communications systems that are available to the mobile device may change as the position of the mobile device and its surrounding environment changes. To provide the user of the mobile device with the best combination of high quality and low cost, many mobile devices periodically attempt to acquire and register with a wireless communications system that is more desirable than the current wireless communications system used by the mobile device. The mobile device searches the systems table for wireless communications systems in its geographic region that are more desirable than the current system used by the mobile device and if more desirable systems are found in the systems table, the mobile device will switch away from the current communications channel and attempt to acquire and register with one of the more desirable systems.

A system acquisition sequence, such as the system acquisition sequences described above, will often include a series of failed attempts to acquire a signal and register with the corresponding wireless communications system, followed by a single successful system acquisition and registration. A preferred roaming list typically includes over 50 systems and under certain conditions the mobile device may spend over 60 seconds stepping through the systems in the preferred roaming list before an acquisition attempt is successful. These failed acquisition attempts are common and may be caused by a variety of factors. For example, the mobile device may be unable to detect a pilot signal transmitted from a system base station if the pilot signal is blocked or weakened by physical obstructions, or if the mobile device is outside the base station's coverage area. Registration with the system may fail if the mobile device and the system use incompatible protocol revisions and hardware, or if system otherwise rejects the registration attempt of the mobile device.

In view of the above, there is a need in the art for a method and apparatus for efficiently selecting and acquiring a wireless communications system.

### SUMMARY OF THE INVENTION

The present invention is a method and apparatus for efficiently selecting and acquiring a wireless communications system. In a preferred embodiment, a mobile station selects a group of wireless communications systems in accordance with a predetermined system acquisition procedure. The selected group of systems has an order of priority, such as a preference order determined by a wireless services provider, that may be used by the mobile station during system acquisition and registration attempts. Next, received signals corresponding to each of the selected systems are analyzed to determine the likelihood that each of the corresponding systems would be acquired by the mobile station. The group of wireless communications systems is then reprioritized based on the results of the analysis to produce a more efficient system acquisition order. The mobile station attempts to acquire and register with one of the systems in the reprioritized group of wireless communications systems in accordance with the acquisition order specified by the group.

The mobile station preferably includes processing circuitry, a memory, a communications transceiver and an antenna. The processing circuitry includes a control processor for controlling the operation of the mobile station, a signal processor, a searcher and a system determination unit. In a preferred embodiment, the mobile station is a multi-mode device and the processing circuitry is adapted to operate in either CDMA or AMPS mode. The memory preferably includes both volatile and nonvolatile random access memories that store a preferred roaming list, including a systems table and an acquisition table, and one or more lookup tables such as a candidates list. The system determination unit is adapted to select one or more wireless communications systems from the systems table in accordance with a system acquisition procedure. In a preferred embodiment, the system determination unit stores the selected systems in the candidates list and instructs the searcher to analyze a received signal corresponding to each of the systems in the candidates list. For each listed system, the searcher instructs the transceiver to switch to the system's corresponding channel and a received signal is analyzed. The analysis of the received signals may include measuring the received signal strength (Rx) of each system, measuring the signal to noise ratio E_{c}/Iₒ, or other tests that assist in determining whether the candidate system is likely to be acquired, provided that the test requires less than time than a complete system acquisition and registration attempt.

After each system is analyzed, the group of selected systems is reprioritized based on the results of the analysis. In a preferred embodiment, all of the systems are sorted such that those systems having the highest likelihood of being acquired are selected first. In a first alternative embodiment, the order of desirability is maintained and, at each level of desirability, the selected systems are sorted using the analysis results. In a second alternative embodiment, the desirability information for each selected system is adjusted based on the analysis results and the group of selected systems is then sorted using the adjusted desirability information. In a third alternative embodiment, each system having a corresponding analysis result that is lower than a threshold value is removed from the group of selected systems.

The mobile station next attempts to acquire and register with a wireless communications system. The system having highest level of priority is selected first from the reprioritized candidates list and an attempt is made to acquire and register with the selected system. Any system acquisition method may be used including conventional system acquisition methods that are well-known in the art. If the acquisition/registration attempt is not successful, then the wireless communications system having the next highest priority is selected from the candidate's list and another acquisition/registration is attempted. This process continues until a system acquisition/registration attempt is successful, or until there are no additional candidate systems. In a preferred embodiment, if the acquisition/registration attempt is successful the wireless communications system is used for future wireless communications services. In an alternative embodiment, the acquired wireless communications system has a known geographic region and an attempt is made to acquire and register with a more preferred wireless communications system in the geographic region.

In a first alternative system acquisition sequence, a first system is selected in accordance with a system acquisition procedure. Any system acquisition procedure may be used, including selecting the system that was the most recently used by the mobile station. The signal quality of the selected system is measured and if the system is not likely to be acquired, then the next system is selected in accordance with the system acquisition procedure. If a selected system is likely to be acquired then an attempt is made to acquire and register with the selected system. If the acquisition/registration attempt is successful then the wireless communications system is used for future wireless communications services. Otherwise, the next system is selected in accordance with the system acquisition procedure.

A more complete understanding of the Method and Apparatus for Efficient Selection and Acquisition of a Wireless Communications Systems will be afforded to those skilled in the art, as well as a realization of additional advantages and objects thereof, by a consideration of the following detailed description of preferred embodiments. Reference will be made to the appended sheets of drawings, which will first be described briefly.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 illustrates a preferred embodiment of the present invention;

FIG. 2 is a mobile station in accordance with a preferred embodiment of the present invention;

FIG. 3a is a systems table in accordance with a preferred embodiment of the present invention;

FIG. 3b is an acquisition table in accordance with a preferred embodiment of the present invention;

FIG. 4 illustrates preferred lookup tables used by the mobile station in accordance with a preferred embodiment of the present invention;

FIG. 5 is a flow diagram illustrating a preferred system selection and acquisition procedure; and

FIG. 6 is a flow diagram illustrating an alternative system selection and acquisition procedure.

### DETAILED DESCRIPTION OF A PREFERRED EMBODIMENT

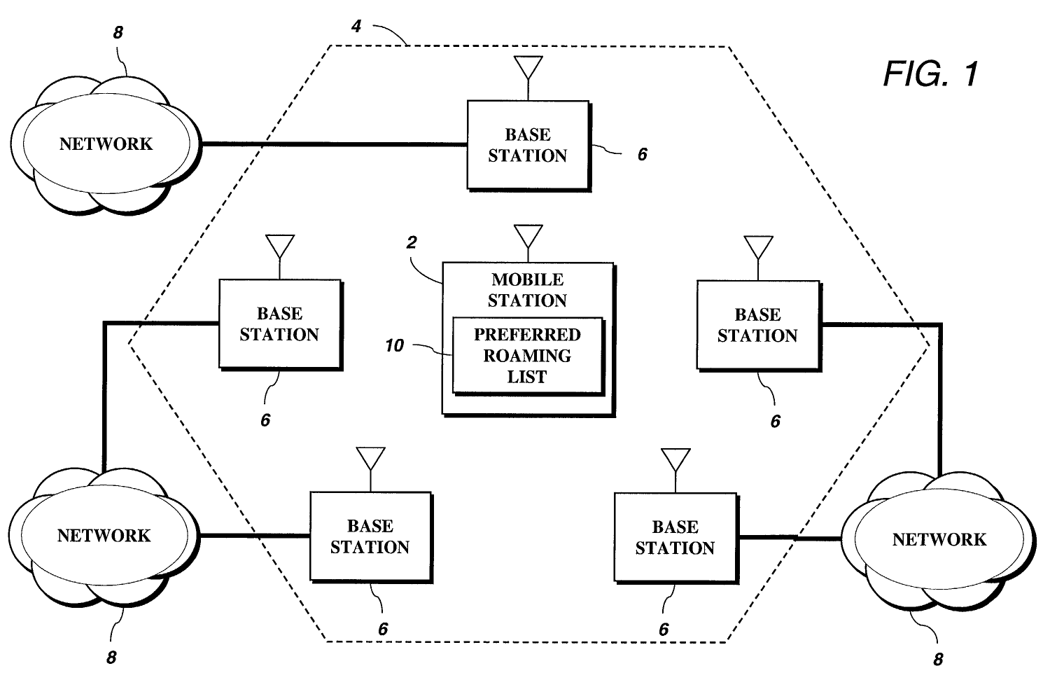

A preferred embodiment of the present invention will now be described with reference to FIG. 1. A mobile station 2 operates in a geographic region 4 that is serviced by at least one base station 6. Each base station 6 is connected to a network 8, which is part of a larger wireless communications system that supports at least one multiple-access wireless communications protocol, such as code division multiple access (CDMA), wideband CDMA (WCDMA), Advanced Mobile Phone Service (AMPS), Global System for Mobile communications (GSM), General Packet Radio Services (GPRS) or High Data Rate (HDR) technology (e.g., 1xEV technology). The mobile station 2 may be any wireless device, whether stationary or mobile, that is adapted for wireless communications with at least one base station 6, such as a cellular telephone, pager, personal digital assistant (PDA), vehicle navigation system or portable computer. In a preferred embodiment, the mobile station is a multi-mode device that is adapted to operate in both CDMA and AMPS modes.

The mobile station 2 includes a list of known wireless communications systems, such as preferred roaming list (PRL) 10. The PRL 10 is stored in a nonvolatile memory of the mobile station 2 and includes a list of wireless communications systems and corresponding acquisition parameters that are used by the mobile station 2 during attempts to acquire and register with a wireless communications system. In a preferred embodiment, the wireless communications systems listed in the PRL 10 are grouped by geographic region and sorted from the most desirable to the least desirable system in each region. As known in the art, the PRL 10 may be maintained by the mobile station's wireless service provider and include a list of wireless communications systems that are available to the mobile station 2 through its wireless service provider or other wireless service providers that have agreed to provide roaming services to the mobile station 2.

In operation, the mobile station 2 attempts to acquire and register with an available wireless communications system that offers wireless services to the mobile station 2. First, a group of wireless communications systems is selected from the PRL 10 in accordance with a predetermined system acquisition procedure. The group of systems has an order of priority that may be used by the mobile station 2 during system acquisition and registration attempts. For example, in a preferred embodiment the wireless communications systems in the mobile station's geographic region 4 are selected and sorted from the most desirable to the least desirable system in each region. Next, received signals corresponding to each of the selected systems are analyzed to determine a relative likelihood that each of the corresponding systems would be acquired by the mobile station 2. The group of wireless communications systems is then reprioritized based on the results of the analysis to produce a more efficient system acquisition order. The mobile station 2 selects the system from the reprioritized group that has the highest relative priority and attempts to acquire and register with the selected system. If the acquisition/registration attempt is successful, the selected system is used by the mobile station 2 for wireless communications. Otherwise, an attempt is made to acquire/register with the system from the group having the next highest priority.

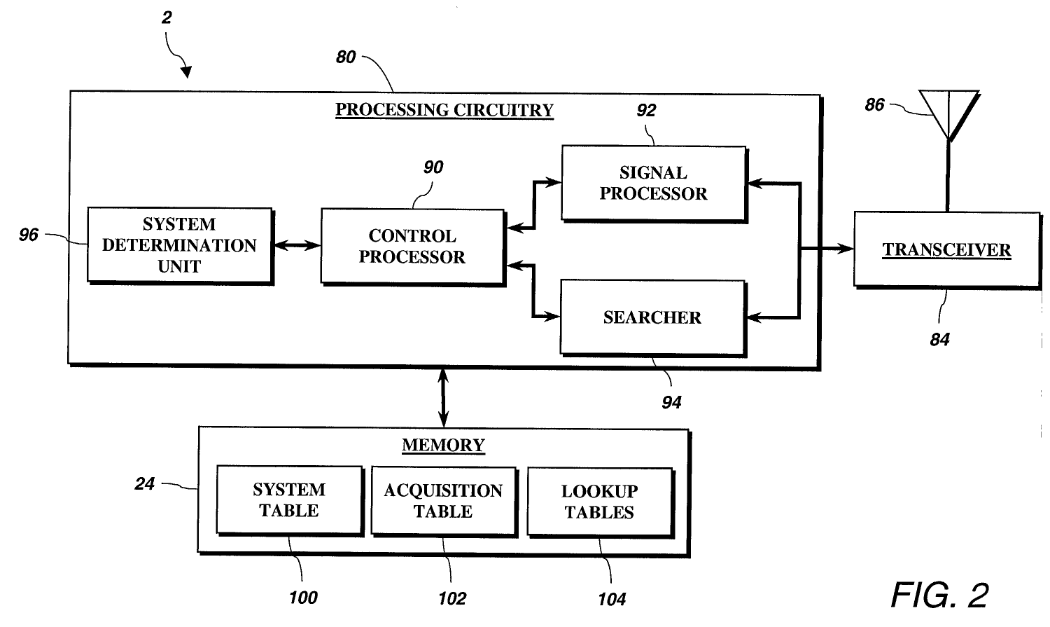

Referring to FIG. 2, a preferred embodiment of the mobile station 2 will now be described. The mobile station 2 includes processing circuitry 80, a memory 82, a communications transceiver 84 and an antenna 86. The processing circuitry 80 preferably includes a control processor 90 for controlling the operation of the mobile station 2, a signal processor 92, a searcher 94 and a system determination unit 96. The memory 82 preferably includes both volatile and nonvolatile random access memories that store a preferred roaming list, including a systems table 100 and an acquisition table 102. The memory 82 may also store one or more lookup tables, such as a list of the most recently used systems 106, and program instructions for execution by the processing circuitry 80.

The searcher 94 is adapted to identify valid signals, such as pilot signals, synchronization channels and paging channels received by the transceiver 84 through the antenna 86. The design and implementation of searcher hardware for CDMA acquisition is described in U.S. Pat. No. 5,109,390, entitled “DIVERSITY RECEIVER IN A CDMA CELLULAR TELEPHONE SYSTEM,” assigned to the assignee of the present invention, and is incorporated herein by reference. The searcher 94 is further adapted to perform a preliminary acquisition analysis of one or more candidate communications systems.

The system determination unit 96 is adapted to select one or more wireless communications systems from the systems table 100 and retrieve corresponding acquisition parameters from the acquisition table 102. The system determination unit 96 is further adapted to forward the acquisition parameters to the searcher 94, which attempts to acquire one the selected systems. In an alternative embodiment, the system determination unit 96 determines whether the current wireless communications system is the most desirable system in the mobile device's current geographic region and, when more desirable systems are available, initiates attempts by the mobile station 2 to acquire a more desirable system. A method and apparatus for performing preferred system selection in a mobile station that is capable of operation in a plurality of geographic regions is disclosed in U.S. Pat. No. 6,085,085, entitled “METHOD AND APPARATUS FOR PERFORMING PREFERRED SYSTEM SELECTION,” assigned to assignee, and is incorporated herein by reference.

It should be appreciated that the mobile station 2 illustrated in FIG. 2 is merely illustrative and that alternative configurations and additional features are contemplated within the scope and spirit of the present invention. For example, the components of the mobile station 2 may be implemented in numerous hardware configurations using conventional circuit elements such as one or more processors, memories and application specific integrated circuits (ASICs). The mobile station 2 may also be adapted for voice communications, high-speed data communications, video communications, internet applications such as email and World Wide Web access, position location (e.g., gpsOne™ developed by assignee), personal navigation, voice recognition, integrated removable storage devices and short-range wireless connectivity with local peripherals and devices. In a preferred embodiment, the processing circuitry 80 includes a Mobile Station Modem chipset, developed by assignee, which integrates digital and analog functions along with GPS-based position location.

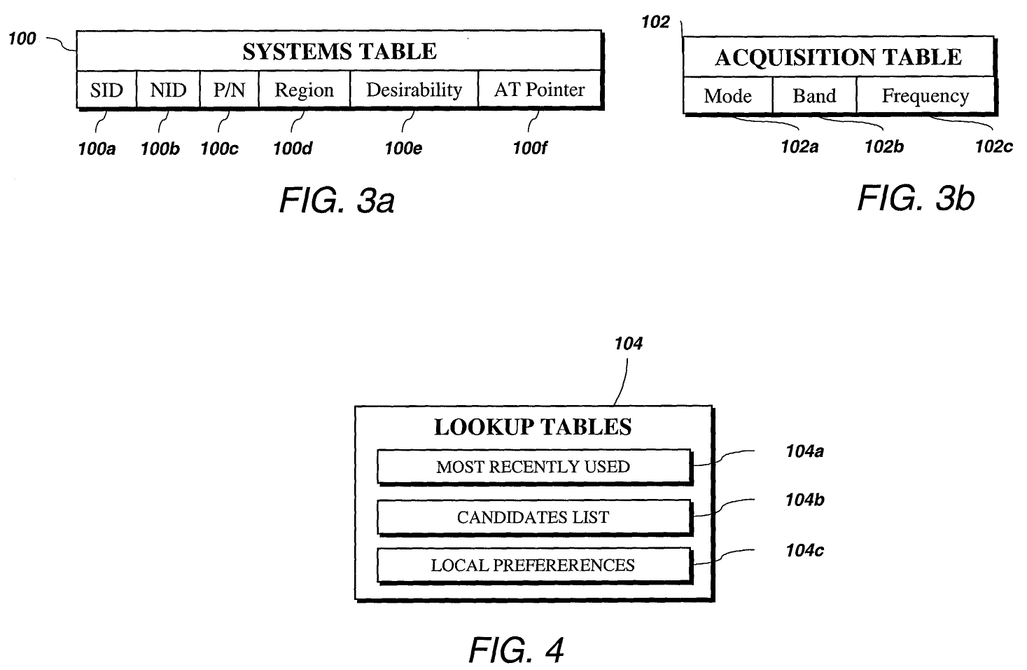

Referring to FIGS. 2 and 3a, a preferred embodiment of the systems table 100 will now be described. The systems table 100 includes a list of wireless communications systems that the mobile station 2 uses during attempts to acquire and register with a wireless communications system. As illustrated, each record in the systems table 100 preferably includes a system identifier (SID) 100a, a network identifier (NID) 100b, an indication of whether the system is preferred or negative (P/N) 100c, an identifier of the geographic region (Region) 100d that is covered by the system, desirability information 100e and a pointer (AT Pointer) 100f to a record in the acquisition table 102. Each wireless communications system listed in the systems table 100 is identified through a unique SID 100a, NID 100b pair and is designated as either a preferred system that may be used by the mobile station 2 during roaming, or a negative system that should not be used by the mobile device 2 during roaming through P/N 100c. In alternative embodiments, the wireless communications systems listed in the systems table 100 may be identified using other system identifiers, such as a unique band, mode and frequency, and Internet Protocol Version 6 (IPV6) address or a Public Land Mobile Network (PLMN) identifier. The wireless communications systems are preferably grouped by geographic region 100d and stored in the systems table 100 in sorted order from the most desirable system to the least desirable system in each region using the desirability information 100e.

Referring to FIG. 3b, a preferred embodiment of the acquisition table 102 will now be described. The acquisition table 102 includes a list of parameters that are necessary for the acquisition of the wireless communications systems listed in the systems table 100. As illustrated, each record in the acquisition table 102 preferably includes a mode 102a, a band 102b and a frequency 102c. The systems table 100 and the acquisition table 102 are preferably stored in a nonvolatile memory and updated periodically by an external source, such as the mobile station's wireless service provider, through downloads across a wireless connection or through another data transfer method. It will be appreciated that alternative configurations for the PRL, the systems table 100 and the acquisition table 102, and alternative identification and acquisition parameters may be used in accordance with the present invention.

As illustrated in FIG. 4, the memory also includes one or more lookup tables 104. In a preferred embodiment the lookup tables include a most recently used (MRU) systems table 104a that stores a list of the systems most recently used by the mobile station 2, a candidates list 104b that includes a list of systems that have been selected as candidates for acquisition, and a preferences table 104c that maintains local preference settings for the mobile station 2. Other information may also be stored in a lookup table including historical information that tracks the use of each system. The lookup tables are preferably stored in volatile portion of the memory 24, but in alternate embodiments, one or more of the lookup tables may be stored in a nonvolatile portion of the memory 24.

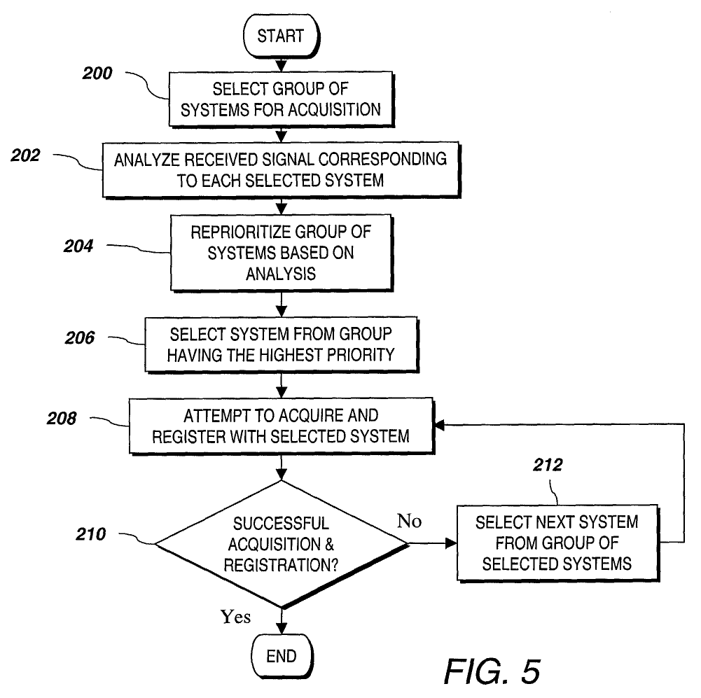

A preferred system acquisition sequence for the mobile station 2 will now be described with reference to FIG. 2 and the flow diagram of FIG. 5. The system acquisition sequence is preferably performed by the system determination unit 96. In Step 200, a group of wireless communications systems is selected from a stored list of systems in accordance with a predetermined system acquisition procedure. In a preferred embodiment, wireless communications systems in the mobile station's geographic region 4 are selected from the system table 100, and the corresponding system identifiers are stored in the candidates list 104b in the memory 24. In alternative embodiments, the candidates list 104b may include other data such as corresponding acquisition parameters and desirability information for the selected systems. The candidates list 104b is preferably sorted in an initial order of priority (e.g., from the most desirable system to the least desirable system) as determined by the predetermined system acquisition procedure. Although system selection using a PRL is illustrated, it will be appreciated that the other system acquisition procedures may be used in accordance with the preferred embodiment of the present invention. For example, in alternative embodiments the system acquisition procedure may include selecting a group of systems from the MRU 104a or other stored systems lists.

As known in the art, the system table 100 specifies a preferred system acquisition order to be used by the mobile station 2 during system acquisition/registration attempts. This system acquisition order, however, is not always the most efficient system selection order for acquiring and registering with a wireless communications system. The selection order specified by the system table 100 is typically determined by the mobile station's wireless services provider based on factors that are unrelated to the likelihood that each of the listed systems will be acquired by the mobile station 2. For example, the desirability of each system may be determined using criteria such as the cost of using the system, the quality of the communications service offered by the system, protocol used by the system, support for unique features and whether the mobile station 2 is listed as a subscriber of the wireless communications system.

To improve the efficiency of the system acquisition/registration process, the mobile station 2 analyzes a received signal corresponding to each of the systems in the candidates list 104b (Step 202) and adjusts the system acquisition order based on the results of the analysis (Step 204). In a first preferred embodiment, the analysis of the received signals includes measuring the received signal strength (Rx) of each system. In operation, the searcher 94 steps through the systems identified in the candidates list 104b stored in the memory 24. In an alternative embodiment, the candidates list may be transmitted to the searcher 94 from the system determination unit 96. For each listed system, the searcher 94 instructs the transceiver 84 to switch to the system's corresponding channel. The received signal strength is then measured and stored in the candidates list 104b. If the received signal strength measurement is relatively low, there would be a low probability that the candidate system would be available for acquisition. If the received signal strength measurement is relatively high, there would be a greater probability that the candidate system could be acquired. It will be appreciated that signal strength measurements for a group of systems can typically be completed in significantly less time than an attempt to acquire and register with each system in the group. In alternate embodiments, other tests that assist in determining whether the candidate system is likely to be acquired may be performed on the received signals.

In a first alternative embodiment, the analysis of the received signals includes determining whether the received signal is likely to be a CDMA signal. In this embodiment, the system determination unit 96 instructs the searcher 94 to measure the signal to noise ratio E_{c}/Iₒ, where E_{c} is the strength of the received signal and Iₒ is the total thermal noise received on the channel. In a CDMA system, this measurement provides an indication of the portion of the received signal that is usable. If the ratio E_{c}/Iₒ is relatively large, then there is a high probability that the system could be acquired. The ratio E_{c}/Iₒ provides a more reliable indication of whether the signal is likely to be acquired than the measured raw strength of the signal.

In a second alternative embodiment, the system determination unit 96 and searcher 94 support multiple test modes and methods of acquisition, and may be adapted to use more than one type of analysis, alone or in combination. The test mode may be determined by user preference, configuration of the mobile station, current operating state of the mobile station or other criteria. The searcher 94 preferably operates in accordance with instructions received from the system determination unit 96 and the system determination unit 96 is adapted to transmit a candidate systems test instruction and a system acquisition instruction. The candidate systems test instruction includes parameters to identify the candidate list, an identifier of the test to be performed on each candidate system and a minimum threshold value to be met by each system. The searcher 94 executes the received instruction and returns the candidate systems that meet the testing requirements. In a preferred embodiment, the searcher 94 modifies the candidates list stored in memory. The system determination unit 96 is further adapted to analyze the test results and transmit a system acquisition instruction to the searcher 94, including parameters identifying the candidates lists.

In Step 204, the group of selected systems is reprioritized based on the analysis to produce a more efficient system acquisition order. In a preferred embodiment, all of the systems are sorted such that those systems having the highest likelihood of being acquired are selected first. In a first alternative embodiment, a plurality of the selected systems have the same level of desirability. At each level of desirability, the selected systems are sorted using measured signal strength, from the most likely system to be acquired to the least likely system to be acquired. In a second alternative embodiment, the desirability information for each selected system is adjusted based on the test measurement. For example, the relative desirability of systems having a signal strength measurement greater than a first threshold value may be adjusted upward, while the relative desirability of systems having a signal strength lower than a second threshold value may be adjusted downward. The group of selected systems is then sorted using the adjusted desirability information. In a third alternative embodiment, systems having a tested signal quality that is lower than a threshold value are removed from the group of selected systems. For example, candidate systems that have a corresponding measured signal strength lower than −90 db may be eliminated from the candidates list. Other criteria may also be used to eliminate and sort candidate systems. For example, a weighting factor may be used that takes into account the measured signal strength, whether the system was recently used, the desirability rating and other information.

After the group of selected systems is reprioritized, the mobile station 2 attempts to acquire and register with one of the wireless communications systems in the group. In Step 206, the system having highest level of priority is selected from the candidates list 104b. In a preferred embodiment, this system has a relatively high desirability level and a high likelihood that the acquisition/registration attempt will be successful based on a measured signal quality such as a signal strength measurement. An attempt is made to acquire and register with the selected system in Step 208. Any system acquisition method may be used including conventional system acquisition methods that are well-known in the art. In a preferred embodiment, the mobile station 2 is adapted to acquire a CDMA system. To acquire a CDMA system, the searcher 94 instructs the transceiver 84 to switch to the communications channel of the selected CDMA system and listens for a pilot signal. The searcher 94 attempts to verify the received pilot signal by testing various pseudorandom noise (PN) offsets in the received signal until a match is found. When the pilot signal is acquired, the processing circuitry 80 receives information for the forward CDMA channel and a phase reference for signal demodulation. Next, the processing circuitry 80 attempts to acquire the synchronization channel associated with the identified pilot channel. The synchronization channel transmits basic system information such as the unique SID/NID of the transmitting wireless communications system and network, and synchronization information. The processing circuitry 80 adjusts its timing in accordance with the received information and then switches to the base station's paging channel. The paging channel is used by a local base station of the current communications system to communicate with the mobile station 2 when the mobile station 2 is not assigned to a traffic channel. Through the paging channel, the base station notifies the mobile station 2 of incoming messages, such as an incoming telephone call or a notification of a received voicemail message.

If the acquisition/registration attempt is successful (Step 210) then the selected system is used by the mobile station 2 for wireless communications. If the acquisition/registration attempt is not successful, the wireless communications system having the next highest priority is selected from the candidate's list in Step 212 and control returns to Step 208 for the next acquisition/registration attempt. If the searcher 94 is unable to acquire the selected system (Step 210) the searcher 94 will attempt to acquire each of the remaining systems according to the selection order until a wireless communications system is acquired or the candidate systems are exhausted. In an alternative embodiment, if the acquisition/registration attempt is successful in Step 210, then the process returns to Step 200 for the selection of a group of systems in the current geographic region that are more desirable than the selected system.

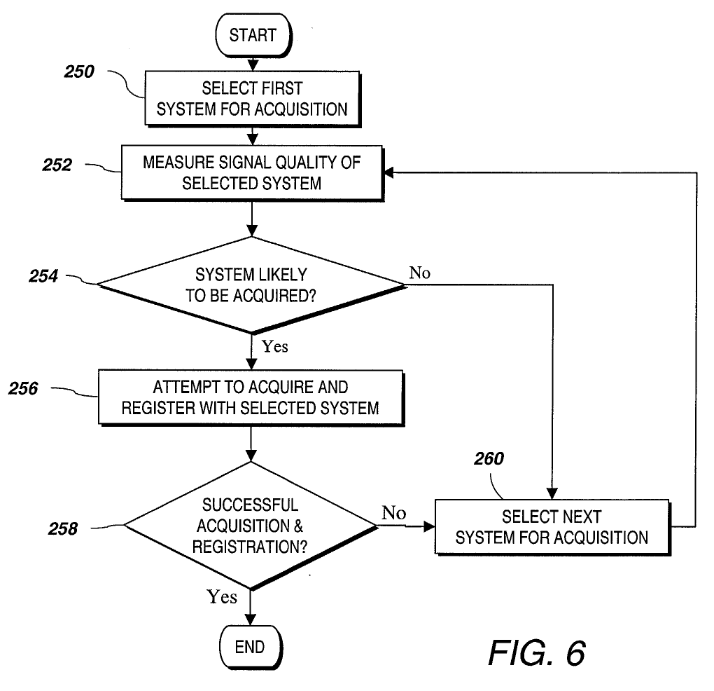

An alternative system acquisition sequence is illustrated in the flow diagram of FIG. 6. In Step 250, a first system is selected in accordance with a system acquisition procedure. Any system acquisition procedure may be used, including selecting the system that was the most recently used by the mobile station 2. The signal quality of the selected system is measured in Step 252. If the system is likely to be acquired (Step 254) then an attempt is made to acquire and register with the selected system in Step 256. In a preferred embodiment, the system is likely to be acquired if the measured signal quality exceeds a predetermined threshold value. If the system is not likely to be acquired, then the next system is selected in accordance with the system acquisition procedure in Step 260. If the acquisition/registration attempt is successful (Step 258) then the mobile station 2 uses the selected system for future wireless communications services. If the acquisition/registration attempt is not successful then the next wireless communications system is selected in Step 260 and control returns to Step 252.

Having thus described a preferred embodiment of the Method and Apparatus for Efficient Selection and Acquisition of a Wireless Communications System, it should be apparent to those skilled in the art that certain advantages of the within described system have been achieved. It should also be appreciated that various modifications, adaptations, and alternative embodiments thereof may be made within the scope and spirit of the present invention.

The scope of the present invention is defined by the following claims.

1. In a mobile station storing a list of wireless communications systems, a system acquisition procedure comprising the steps of:
selecting a group of wireless communications systems from the list in accordance with a predetermined system acquisition procedure, the group of wireless communications systems having a first system acquisition order;
measuring a signal quality for each of the selected systems;
reprioritizing the group of wireless communications systems in accordance with the measured signal quality, the reprioritized group of wireless communications systems having a second system acquisition order; and
attempting to acquire the wireless communications system having the highest priority in accordance with the second system acquisition order.

2. The method of claim 1 wherein the list of wireless communications systems is a preferred roaming list including a geographic region identifier and the step of selecting a group of wireless communications systems includes determining a current geographic region of the mobile station and selecting the listed wireless communications systems having a geographic region identifier that corresponds to the current geographic region of the mobile station, and
wherein the first system acquisition order is based on the relative order of the selected wireless communications systems in the preferred roaming list.

3. The method of claim 2 wherein each wireless communications system identified in the preferred roaming list has a corresponding desirability level, at least two of the selected systems sharing the same level of desirability, and
wherein the step of reprioritizing comprises locating selected systems that share the same desirability level and sorting the located systems by the measured signal strength.

4. The method of claim 3 wherein each wireless communications system identified in the preferred roaming list has a corresponding desirability level and the step of reprioritizing comprises the steps of:
for each selected system, adjusting the corresponding desirability level based on the corresponding measured signal strength, the adjusted desirability criteria being stored in the group of wireless communications systems; and
sorting the group of wireless communications systems by the adjusted desirability levels.

5. The method of claim 1 wherein the step of reprioritizing comprises removing a selected system from the group if its corresponding measured signal quality fails to meet a minimum threshold.

6. The method of claim 1 wherein the step of measuring a signal quality includes calculating a ratio E_{c}/Iₒ of the received signal.

7. A mobile station comprising:
a memory storing a preferred roaming list, the preferred roaming list including a first plurality of system identifiers and corresponding acquisition parameters; and
a processing circuitry adapted to select wireless communications systems from the preferred roaming list in accordance with a predetermined system acquisition procedure, the selected wireless communications systems have a corresponding system acquisition order,
wherein the processing circuitry is further adapted to measure a signal quality of each selected system and modify the system acquisition order based on the measured signal qualities, the modified system acquisition order increasing the efficiency of the system acquisition process.

8. The mobile station of claim 7 wherein the selected wireless communications systems include corresponding desirability criteria, and
wherein the processing circuitry is further adapted to adjust the corresponding desirability criteria of a selected system if the corresponding signal strength measurement exceeds a first threshold, and sort the selected wireless communications systems using the adjusted desirability criteria.

9. The mobile station of claim 7 wherein the measured signal quality for each system includes a signal-to-noise ratio of the received signal, the signal-to-noise ratio corresponding to a likelihood that the corresponding system would be acquired.

10. In a multi-mode mobile station adapted to operate in CDMA and AMPS modes, a method for acquiring a wireless communications system comprising the steps of:
analyzing a signal received on a channel associated with a candidate communications system;
determining, based on the analysis of the received signal, whether the candidate communications system is likely to be available for acquisition by the mobile station; and
attempting to acquire the candidate communications system only if the candidate communications system is likely to be available for acquisition.

11. The method of claim 10 wherein the step of analyzing comprises switching to a channel associated with the candidate communications system and testing a signal quality of the received signal.

12. The method of claim 11 wherein the mobile station includes a table of known communications systems, each known communications system having a relative desirability, and wherein the candidate communications system is selected from the table of known communications systems in accordance with a predetermined system acquisition procedure.

13. The method of claim 11 wherein the tested signal quality is a received signal strength measurement.

14. The method of claim 11 wherein the tested signal quality is a signal-to-noise ratio of the received signal.

15. The method of claim 11 wherein the candidate communications system is likely to be available if the measured signal quality exceeds a predetermined threshold value.

16. The method of claim 11 further comprising the step of selecting a set of candidate communications systems, wherein the steps of analyzing and determining are repeated for each candidate communications system in the set and the step of attempting is performed for the candidate communications system that is most likely to be acquired.

17. The method of claim 16 further comprising the step of sorting the candidate communications systems in order of measured signal quality, the sorted order defining an acquisition order for the set of candidate communications systems.

18. In a wireless device, an integrated circuit comprising:
a system determination unit adapted to identify candidate communications systems in a current geographic region of the wireless device; and
a searcher coupled to the system determination unit, the searcher adapted to analyze a signal quality of at least one of the identified wireless communications systems to determine a likelihood of whether the wireless communications system will be acquired.

19. The integrated circuit of claim 18, wherein the searcher measures the strength of a received signal corresponding to each identified wireless communications system.

20. The integrated circuit of claim 18, wherein the searcher calculates the signal-to-noise ratio E_{c}/Iₒ of a received signal for each identified wireless communications system.

21. The integrated circuit of claim 18 further comprising a memory coupled to the system determination unit, the memory storing a list of known communications systems, each known communications system having an associated geographic region and relative desirability,
wherein the systems analyzed by the searcher are selected from the system table by the system determination unit.

22. The integrated circuit of claim 18 wherein the system determination unit is adapted to transmit an instruction to the searcher, the instruction including a test identifier; and
wherein, in response to a received instruction, the searcher analyzes the signal quality of at least one of the identified wireless communications systems using a test method identified by the test identifier.

23. The integrated circuit of claim 22 wherein the transmitted instruction further includes a threshold value, and wherein the searcher transmits a notification message to the system determination unit when at least one analyzed signal quality exceeds the threshold value.
